(19) United States
(12) Patent Application Publication
(10) Pub. No.: US 2011/0184893 A1
(43) Pub. Date: Jul. 28, 2011

(54) ANNOTATING QUERIES OVER STRUCTURED DATA

(75) Inventors: Stelios Paparizos, Mountain View, CA (US); Nikolaos Sarkas, Toronto (CA); Panayiotis Tsaparas, San Francisco, CA (US)

(73) Assignee: Microsoft Corporation, Redmond, WA (US)

(21) Appl. No.: 12/694,294

(22) Filed: Jan. 27, 2010

(51) Int. Cl. G06F 7/10; G06F 17/30; G06F 15/18

(52) U.S. Cl. 706/12; 707/780; 707/768; 707/E17.014; 707/769; 707/E17.081

(57) ABSTRACT

A query may be received at a computing device and may include one or more terms. For each set of structured data tuples, a set of tokens may be determined from the terms of the query by the computing device based on attribute values of attributes associated with the structured data tuples in the set of structured data tuples. An annotated query may be determined from each of the sets of tokens. A probability score may be determined for each of the determined annotated queries. The annotated query having the highest determined probability score may be selected, and one or more structured data tuples may be identified from the structured data tuples that have attributes with attribute values that match one or more tokens of the selected annotated query.

### BACKGROUND

Structured data sources typically include structured data tuples of attributes stored in a database. Each attribute may have one of several attribute values. Examples of structured data sources include product databases, movie schedule databases, and airline flight databases. Because structured data sources have well defined attributes (schema), they are typically queried using methods that take advantage of the underlying schema such as a query language like SQL or using a form in a website. For example, a user may search flights at a travel website by entering a date in a form box corresponding to a date, a city into a form box corresponding to a destination, and a city into a form box corresponding to an origination. Because the travel website enforces the schema of the underlying structured data, the structured data can be easily searched by matching the entered attribute values with attribute values of their corresponding attribute in the structured data.

As the power of search engines has grown, users have become more comfortable making free form text based queries by typing one or more terms into a single box at a search engine. For example, a user may enter one or more terms into a single query box at websites such as Bing or Google. These types of searches typically result in the search engine returning web pages having text that matches one or more of the terms of the query. While this method is useful for searching text based web pages, as more and more data is stored in structured data, it is difficult to efficiently and accurately provide search results that include structured data based on free form queries because the attributes corresponding to the terms of the query is unknown. For example, a term of a query may match several attribute values of the structured data, making it difficult to match the terms of free form query with the correct attributes of the structured data. In addition, there may be terms of the query that have no matching attribute values, making it difficult to determine what to do with the non-matching terms.

### SUMMARY

An annotated query is generated from a received free form text query. The annotated query may include one or more tokens that have values that correspond to attribute values of attributes from structured data tuples that make up structured data. The annotated query may map the terms of the query to attribute values of attributes of a table of structured data. The annotated query may then be used to identify tuples of structured data that are responsive to the original received free form text query. The tokens of candidate annotated queries are generated from the free form text query by parsing the terms of the received query using a dictionary that includes known attribute values from the structured data tuples. Candidate annotated queries are evaluated using previously generated frequency data for combinations of attribute values of attributes of the structured data tuples of the structured data and pre-computed probabilities of receiving queries having various attribute value combinations. The evaluation includes generating a probability score for each of the candidate annotated queries and comparing the probability score to a dynamic threshold. The dynamic threshold is based on the probability of the terms/tokens comprising the free form query appearing in previously received queries.

In an implementation, a query may be received at a computing device through a network. The query may include one or more terms. For each of a plurality of sets of structured data tuples, a set of tokens may be determined for the set of structured data tuples from the terms of the query by the computing device based on attribute values of attributes associated with the structured data tuples in the set of structured data tuples. An annotated query may be determined from each of the sets of tokens by the computing device.

Implementations may include some or all of the following features. A probability score may be determined for each of the determined annotated queries. All of the annotated queries may be selected. Alternatively, the annotated query having the highest determined probability score may be selected, and one or more structured data tuples may be identified from the plurality of structured data tuples that have attributes with attribute values that match one or more tokens of the selected annotated query.

The probability score for each of the annotated queries may be determined based on predetermined frequencies of the attribute values of the attributes of the structured data tuples in the plurality of sets of data tuples. The probability score for each of the annotated queries may be determined based on predetermined frequencies of terms associated with previously received queries. Selecting the annotated query having the highest determined probability score may include comparing the highest score to a threshold (e.g., a static threshold or a dynamic threshold), and only selecting the annotated query having the highest score if the highest score is greater than the threshold. Alternatively, all the annotated queries having a score over the threshold may be selected. If there are no scores greater than the threshold, then no annotated queries are returned. Each structured data tuple may correspond to a product. A product corresponding to the identified structured data tuple may be determined, and an indicator of the determined product may be provided. A set of tokens for the set of structured data tuples may be determined from attribute values. The tokens in a set of tokens may include free tokens and annotated tokens. Determining an annotated query from each of the sets of tokens by the computing device may include, for each set of tokens, determining an annotated query for one or more combinations of tokens from the set of tokens, determining the annotated query that includes the greatest number of annotated tokens, and selecting the annotated query that is a maximal annotated query.

In an implementation, a plurality of sets of structured data tuples may be received at a computing device through a network. Each structured data tuple may include a plurality of attributes and each attribute may have an associated value. Frequency data may be generated from the plurality of sets of structured data tuples by the computing device, and the frequency data may describe the frequency of one or more combinations of attribute values for the attributes of the structured data tuples in the plurality of sets of structured data tuples. An annotated query may be generated based on the terms of a query for each of the sets of structured data tuples. Each annotated query may include one or more tokens. A probability score may be generated for each of the one or more annotated queries based on the generated frequency data by the computing device.

Implementations may include some of the following features. The generated probability score for each of the one or more annotated queries may be compared with a dynamic threshold. Annotated queries having a generated probability score that is less than the dynamic threshold may be discarded. A structured data tuple having attributes with attribute values that match one or more of the tokens of one or more of the annotated queries may be identified. A product associated with the identified structured data tuple may be identified, and an identifier of the product may be presented in response to the received query.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for annotating queries based on structured data;

FIG. 2 is an illustration of an example query annotator;

FIG. 3 is an operational flow of an implementation of a method for annotating a query and identifying a structured data tuple responsive to the query;

FIG. 4 is an operational flow of an implementation of a method for generating frequency data and generating and scoring an annotated query based on a received query and the generated frequency data; and

FIG. 5 is a block diagram of a computing system environment according to an implementation of the present system.

### DETAILED DESCRIPTION

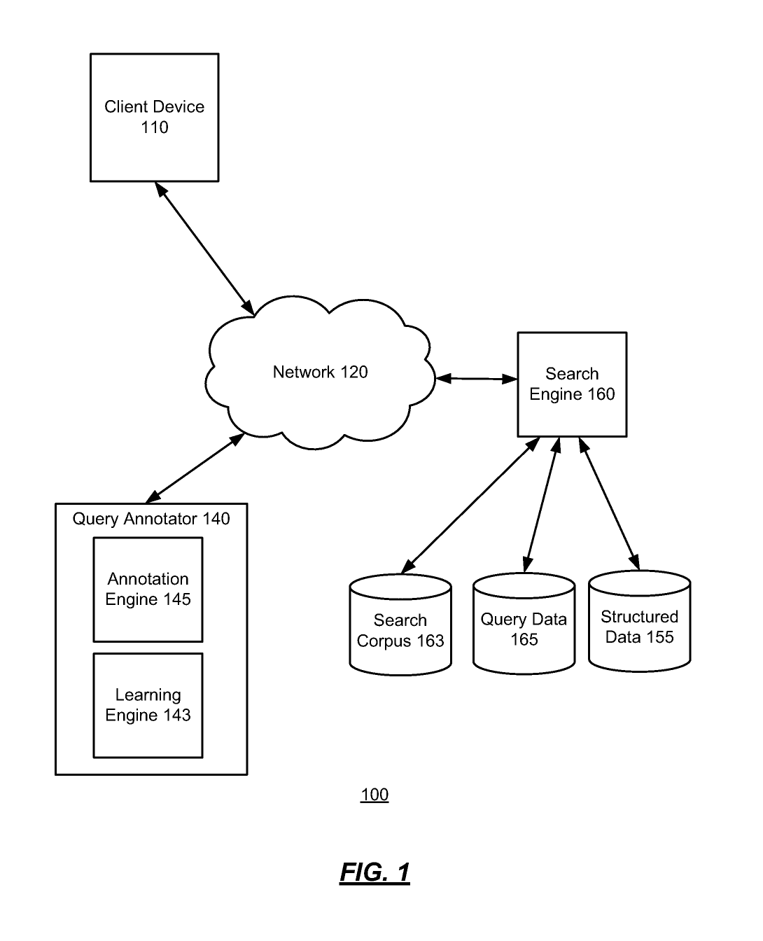

FIG. 1 is an illustration of an exemplary environment 100 for annotating queries based on structured data. A client device 110 may communicate with a search engine 160 through a network 120. The client device 110 may be configured to communicate with the search engine 160 to access, receive, retrieve, and display media content and other information such as web pages and websites. The network 120 may be a variety of network types including the public switched telephone network (PSTN), a cellular telephone network, and a packet switched network (e.g., the Internet). Although only one search engine 160 is shown in FIG. 1, it is contemplated that the client device 110 may be configured to communicate with one or more search engines 160 through the network 120.

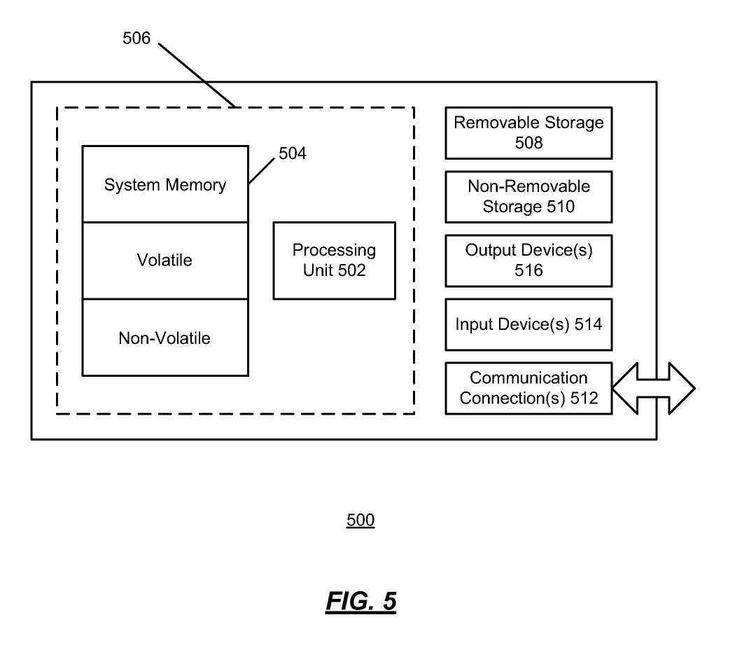

In some implementations, the client device 110 may include a desktop personal computer, workstation, laptop, personal digital assistant (PDA), cell phone, or any WAP-enabled device or any other computing device capable of interfacing directly or indirectly with the network 120. The client device 110 may be implemented using one or more computing devices such as the computing system 500 described with respect to FIG. 5. The client device 110 may run an HTTP client, e.g., a browsing program, such as MICROSOFT INTERNET EXPLORER or other browser, or a WAP-enabled browser in the case of a cell phone, PDA, or other wireless device, or the like, allowing a user of the client device 110 to access, process, and view information and pages available to it from the search engine 160.

The search engine 160 may be configured to provide data relevant to queries received from users using devices such as the client device 110. In some implementations, the search engine 160 may receive a query from a user and fulfill the query using data stored in a search corpus 163. The search corpus 163 may be an index of one or more web pages along with the text of the web pages or keywords associated with the web pages. A received query may have one or more terms corresponding to words or phrases in the query. The search engine 160 may fulfill a received query by searching the search corpus 163 for web pages that are likely to be responsive the query. For example, the search engine 160 may match the terms of the query with the keywords or text associated with the web pages. Indicators of the web pages that match the terms of the received query may be returned to the user at the client device 110 in a web page. In some implementations, the search engine 160 may store one or more logs or records of queries received from users and store them as the query data 165, for example.

In addition to the search corpus 163, the search engine 160 may also fulfill queries from structured data 155. The structured data 155 may include one or more structured data tuples organized into one or more sets or tables corresponding to a variety of categories. Each structured data tuple may correspond to a product or service, and may include one or more attributes corresponding to features of the product or service that the structured data tuple purports to represent. Each attribute may have one or more attribute values. The structured data 155 may be implemented as a database and/or a collection of tables, or as XML data, for example. Any of a variety of known data structures may be used for the structured data 155.

For example, an online retailer may maintain their inventory as structured data 155. A schema specific to the structured data 155 may then be used to generate web pages, catalogs, reports, etc., based on the structured data 155 because of the well defined attributes of the structured data tuples in the structured data 155. The online retailer may provide the structured data 155 to the search engine 160 to use for the fulfillment of queries. Alternatively or additionally, the retailer may allow the search engine 160 to access their structured data 155 directly. Examples of businesses or merchants that may use structured data 155 may include travel websites, movie websites, and libraries.

Thus, the structured data 155 may comprise tables or sets corresponding to particular categories or product classifications (e.g., brand, product type, etc.). Two such example tables are illustrated below as Tables 1 and 2.

TABLE 1
TVs

| TYPE | BRAND | Diagonal |
|---|---|---|
| TV | Samsung | 46 Inch |
| TV | Sony | 60 Inch |
| TV | LG | 26 Inch |

TABLE 2
Monitors

| TYPE | BRAND | Diagonal |
|---|---|---|
| Monitor | Samsung | 26 Inch |
| Monitor | Dell | 12 Inch |
| Monitor | HP | 32 Inch |

Table 1 has three attributes: type, brand, and diagonal. Table 2 has the same attributes. As illustrated, each entry in either of the tables is a structured data tuple representing a particular product having the particular attribute values assigned to each attribute. Each attribute may either be categorical or numerical. A categorical attribute can have an attribute value that is one of a defined set of words or phrases. For example, in Table 1, the attribute brand can have an attribute value of Samsung, Sony, or LG. A numerical attribute has an attribute value that is a number or range of numbers. For example, in Table 1, the attribute diagonal has the attribute values of 46, 60, and 26. The set of categories or range of numbers that an attribute may have as attribute values is referred to herein as its domain.

To facilitate searches on structured data 155, the environment 100 may further include a query annotator 140. The query annotator 140 may receive a query generated by a user at the client device 110 indirectly via the search engine 160, or directly from the client device 110. The query annotator 140 may determine one or more possible annotated queries from a received query that may be used by the search engine 160. An annotated query may represent a possible mapping or translation of the terms of a query to attribute values of attributes of structured data tuples from a table of the structured data 155. Because each table of the structured data may include different attributes with different possible attribute values, there may be multiple possible annotated queries for a received query given the structured data 155.

The annotated query or queries may be used to fulfill the received query from the structured data 155. In some implementations, the query annotator 140 may further generate a probability score for each of the possible annotated queries that represent the likelihood that the annotated query represents the intent of the user that submitted the query from the client device 110. The probability scores may be used by the search engine 160 to select one of the annotated queries and/or to determine whether to fulfill the received query from the search corpus 163 or the structured data 155. For example, if the score for an annotated query is low or below a dynamic threshold, then it may be likely that the received query would be better fulfilled using the search corpus 163. The query annotator 140 may be implemented using one or more computing devices such as the computing system 500 described with respect to FIG. 5, for example.

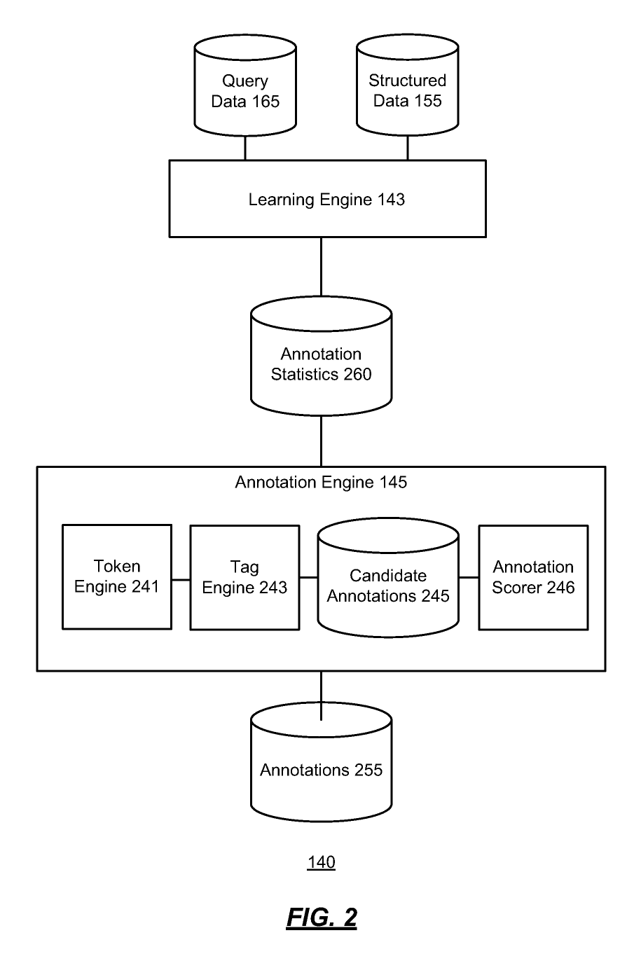

The query annotator 140 may comprise an annotation engine 145. The annotation engine 145 may determine one or more annotated queries based on a received query. The query annotator 140 may determine an annotated query by determining a plurality of tokens based on the terms of a received query. Each token may represent a term or terms found in the query. A token may be either an annotated token or a free token. An annotated token may be a token that represents a term or terms from the received query and matches a known attribute value of an attribute from a table of the structured data 155. For example, a token representing the term “Samsung” in a query would be an annotated token because “Samsung” matches an attribute value of an attribute found in Table 1 of the structured data 155 illustrated above. A free token may be a token representing terms or terms from a query that are not matched to an attribute value of an attribute from a table of the structured data 155. For example, a token representing the term “blue” in a query would be a free token because blue does not match any attribute value of the attributes from the tables of the structured data 155 illustrated above. Example methods and techniques used to generate the tokens by the annotation engine 145 are described further with respect to FIG. 2.

In some implementations, the annotation engine 145 may, for each table or set of structured data tuples in the structured data 155, determine a set of annotated queries that represent the possible annotated and free token combinations for a received query with respect to the set of structured data tuples. Thus, continuing the example above, the annotation engine 145 may determine a set of annotated queries for Table 1 and set of annotated queries for Table 2. The annotation engine 145 may then select the annotated queries determined for each table that are the maximal annotated queries. A maximal annotated query may be the annotated query whose set of annotated tokens are not subsumed or a subset of another annotated query for that table. The selected annotated queries may then be output by the annotation engine 145. The annotation engine 145 may be implemented as one or more computing devices such as the computing system 500 described with respect to FIG. 5, for example.

The query annotator 140 may comprise a learning engine 143. The learning engine 143 may generate statistical data that may be used by the query annotator 140 to score or determine the likelihood of the candidate annotated queries determined by the annotation engine 145. In some implementations, the learning engine 143 may generate the statistical data from the structured data 155 and the query data 165. As described above, the query data 165 may include a history of queries received by the search engine 160 and may therefore indicate popular or frequent searches. Similarly, the structured data 155 may include a large number of attributes and attribute values and may indicate popular or likely attribute values and attribute value combinations for particular tables. Because of the large amount of structured data 155 and query data 165, the learning engine 143 may be an “offline” component and may generate the statistical data for the query annotator 140 to apply to the annotated queries determined by the annotation engine 145 in real time. The learning engine 143 may be implemented as one or more computing devices such as the computing system 500 described with respect to FIG. 5, for example.

FIG. 2 is an illustration of an example query annotator 140. As described above, in an implementation, the query annotator 140 comprises a learning engine 143 and an annotation engine 145. The annotation engine 145 may comprise a token engine 241. The token engine 241 may determine a set of possible tokens from a received query for each set or table of structured data tuples in the structured data 155. The tokens may include annotated tokens. An annotated token may include an indicator of the attribute that has an attribute value that is matched by the token. Tokens that are not matched to an attribute value may be free tokens. For example, a set of annotated tokens for the query “72 inch LG LCD TV” using Tables 1 and 2 with the notation X.Y, where X is the table and Y is the attribute, may include the annotated tokens (72 inch, TV.Diagonal), (72 inch, Monitors.Diagonal), (LG, Monitors.Brand), (LG, TV.Brand), (TV, TV.type), and (LCD). The token LCD is free because LCD is not a valid attribute value from either Table 1 or Table 2.

In some implementations, the token engine 241 may be implemented using a string dictionary implemented as a ternary search tree; however, other techniques may be used. The string dictionary may include some or all of the attributes found in the structured data 155 along with the domain of attribute values for each attribute. For numerical attributes, the string dictionary may include acceptable values or data ranges, for example.

The annotation engine 145 may further comprise a tag engine 243. The tag engine 243 may receive the set of possible annotated and free tokens from the token engine 241 and determine a set of candidate annotated queries based on the tokens. The candidate annotated queries may be stored as the candidate annotations 245, for example. In some implementations, the tag engine 243 may group the determined tokens based on the table of the structured data 155 that they are associated with. For example, the annotation engine 145 may determine the following candidate annotated queries where a token by itself in parenthesis represents a free token:

S1=TV, (72 inch, TV.Diagonal), (LG), (LCD), (TV)

S2=TV, (72 inch, TV.Diagonal), (LG, TV.Brand), (LCD), (TV)

S3=TV, (72 inch, TV.Diagonal), (LG, TV.Brand), (TV, TV.Type), (LCD)

S4=Monitors, (72 inch, Monitors.Diagonal), (LG), (LCD), (TV)

S5=Monitors, (72 inch, Monitors.Diagonal), (LG, TV.Brand), (LCD), (TV)

S6=TV, (72), (inch), (LG,TV.Brand), (LCD), (TV)

As illustrated, there are six different annotated queries that can be generated from the tokens, four from Table 1 (i.e., S1, S2, S3, and S6) and two from Table 2 (i.e., S4 and S5). Because LCD is not an attribute value for either Table 1 or Table 2, LCD is an unmatched free token in all six annotated queries. Similarly, because TV is only an attribute value in Table 1, it is an unmatched free token in both S4 and S5.

In some implementations, the tag engine 243 may determine the annotated queries that are the maximal annotated queries for each set or table of structured data tuples. The maximal annotated query for a table may be the annotated query whose annotated tokens are not a subset of another annotated query. Thus, continuing the above example, the annotated queries S3 and S5 are maximal annotated queries for Tables 1 and 2, respectively. For instance, S1 is not a maximal annotated query since S3 contains the annotated tokens of S1 which are a subset of S3's. Accordingly, the tag engine 243 may store the S3 and S5 queries as the candidate annotations 245.

Given the large number of sets or tables of structured data tuples that may make up the structured data 155, the annotations engine 145 may further include an annotation scorer 246 that may score one or more of the candidate annotations 245. The score may represent the probability or likelihood that a candidate annotation query is representative of the original received query (i.e., when the user generated the query did the user intend to perform a search of the particular table of structured data using the attribute values represented by the annotated query).

In some implementations, the annotation scorer 246 may generate the probability score for a candidate annotated query using Equation 1:

P(S)=P(F|T·A)×P(N|T·A)×P(T·A) Equation 1

In Equation 1, P(T·A) may represent the probability that a user meant to search their submitted query against the table or set T of structured data tuples of the structured data 155 and the set of attributes A from the structured data 155 when they submitted their query. The terms N and F represent the set of annotated and free tokens in the annotated query, respectively. Thus, Equation 1 determines the probability that the user submits a query having the set of annotated tokens N and free tokens F given that they meant to submit a query to the table T over the set of attributes A.

Because users are accustomed to fast responses to queries, it may not be practical for the annotation scorer 246 to calculate Equation 1 for each annotated query. Thus, the learning engine 143 may pre-compute annotation statistics 260 from the query data 165 and the structured data 155. In some implementations, the annotation statistics 260 may be the determined frequencies of some or all possible attribute value combinations for attributes within structured data tuples of the structured data 155.

In some implementations, the learning engine 143 may calculate P(T·A) using an expectation maximization algorithm using the queries that have already been observed (i.e., the query data 165). Values for P(T·A) may then be selected that maximize the likelihood that users generating queries would output the queries that are found in the query data 165. Other methods for calculating P(T·A) may also be used by the learning engine 143.

With respect to the annotated tokens N, the learning engine 143 may pre-compute P(N|T·A) by calculating the number of structured data tuples in the table T that have attributes having attribute values matching N and dividing the number by the total number of structured data tuples in the table T. The learning engine 143 may calculate this value for some or all of the possible sets or combinations of annotated tokens. The calculated values may be stored as the annotation statistics 260 and used by the annotation scorer 246 to generate probability scores for annotated queries. For numerical attributes, the learning engine 143 may pre-compute a probability distribution of the attribute values for each attribute N of the structured data tuples in the table T.

With respect to the free tokens F, the learning engine 143 may pre-compute P(F|T·A) by computing the probability of each free token in F and multiplying (or accumulating) the probabilities. In some implementations, the probability of a free token may be determined by, for each table or set in the structured data 155, compiling a list of words that are related to the table or set. The list of related words may be determined using the attribute values in the table, known synonyms for the attribute vales, as well as terms from the query data 165. Because users are likely to group related terms in a query, terms appearing together often in the query data 165 may be related.

The annotation scorer 246 may use the pre-computed annotation statistics 260 and the candidate annotations 245 to generate probability scores for the candidate annotations 245. The annotation engine 145 may then select the candidate annotations 245 having the highest score as the annotations 255, or alternatively may select all or some other subset of the candidate annotations 245 as the annotations 255. In some implementations, the annotation scorer 246 may additionally compare each score to a dynamic threshold. The dynamic threshold score may be used to exclude implausible or unlikely annotations. If the score for an annotation is below the dynamic threshold, then the annotation may be disregarded by the annotation engine 145. In some implementation, the dynamic threshold is based on the probability of the terms/tokens comprising the free form query appearing in previously received queries. In some implementations, the dynamic threshold may be computed by computing the probability that a free-text query representing the received query is received using the query data 165. If the probability of the annotated query appearing in the table of structured data is below the probability of the free-form version of the query in the query data 165, then the candidate annotation can be discarded. Alternatively, instead of using a dynamic threshold, a static threshold may be used.

The annotation engine 145 may provide the annotations 255 to the search engine 160. The search engine 160 may use the annotated queries of the annotations 255 to identify structured data tuples that are responsive to the received query. Identifiers of the identified structured data tuples may be provided to the client device 110 by the search engine 160 in a webpage, or identifiers of services or products associated with the identified structured data tuples may be provided. In some implementations, the annotations 255 may be stored and/or displayed to the user, for example.

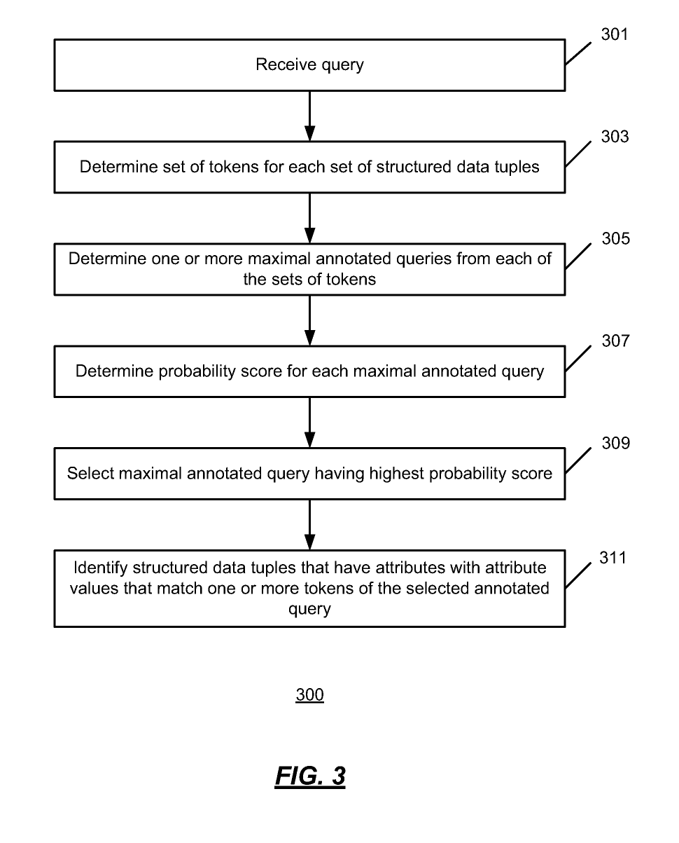

FIG. 3 is an operational flow of an implementation of a method 300 for annotating a query and identifying a structured data tuple responsive to the query. The method 300 may be implemented by one or more of the search engine 160 and the query annotator 140, for example.

A query is received (301). In some implementations, the query may be received by the query annotator 140 or the search engine 160 from a user at a client device 110. The query may comprise one or more terms. In implementations where the query is received by the search engine 160, it may be passed to the query annotator 140 for annotation. For example, a user may have submitted a free form text query. In order to fulfill the query from structured data, the query may be annotated to correspond to the particular attribute and attribute values of the structured data tuples that comprise the structured data.

For each of a plurality of sets of structured data tuples, a set of tokens is determined for the set of structured data tuples (303). The set of tokens may be determined by the token engine 241 of the annotation engine 145 and may be determined from the terms of the query. The structured data 155 may include sets of structured data tuples. Each set may be a table or other data structure and may correspond to a particular category or classification of products or services. For example, one set of structured data tuples may be a table of structured data tuples corresponding to automobiles and another may be a table of structured data tuples corresponding to furniture.

Tokens may be determined by parsing the terms of the query for words or phrases corresponding to the attribute values of a table or set of structured data tuples, or for words that are synonyms for, or are known to be related to, the attribute values. Because each set or table may have its own associated attributes and corresponding attribute values, a set of tokens is generated for each table or set of structured data tuples. The determined tokens may be annotated tokens and free tokens.

One or more maximal annotated query may be determined from each of the sets of tokens (305). The annotated queries may be determined by the tag engine 243 of the annotation engine 145, and may be stored as the candidate annotations 245. In some implementations, the annotated queries for a set of tokens may represent the maximal annotated queries for that table and set of tokens.

A probability score is generated for each of the determined maximal annotated queries (307). The probability score may be generated by the annotation scorer 246 of the annotation engine 145. The probability score for an annotated query may represent the probability that the annotated query accurately represents the intent of the user who submitted the query.

In some implementations, the annotation scorer 246 may generate the probability score based on annotation statistics 260. The annotation statistics 260 may have been previously generated by the learning engine 143 and may describe the frequency of various attribute value combinations for attribute values in the structured data tuples of the structured data 155, as well as the probability of receiving queries with various attribute value combinations from the query data 165. The annotation scorer 246 may determine the probability score for an annotated query using Equation 1 described above. Other techniques may also be used.

The maximal annotated query having the highest determined probability score is selected (309). The annotated query may be selected by the annotation engine 145, for example. In some implementations, the maximal annotated query is further compared to a dynamic threshold score and discarded if the score is below the threshold. The annotated query may be provided to the search engine 160, or alternatively provided or displayed to a user.

One or more structured data tuples from the plurality of structured data tuples are identified that have attributes with attribute values that match one or more tokens of the selected annotated query (311). The one or more structured data tuples may be identified from the structured data 155 by the search engine 160. An identifier of the identified product may be presented to the user who submitted the received query in a webpage, for example.

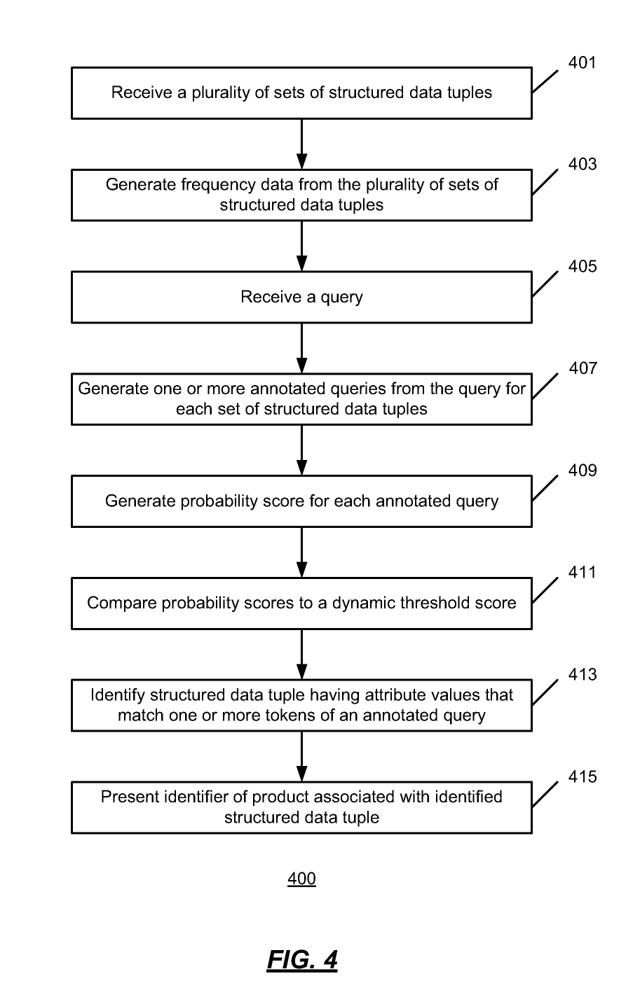

FIG. 4 is an operational flow of an implementation of a method 400 for generating frequency data and generating and scoring an annotated query based on a received query and the generated frequency data. The method 400 may be implemented using one or more of the search engine 160 and the query annotator 140, for example.

A plurality of sets of structured data tuples is received (401). The sets of structured data tuples may comprise tables of the structured data 155 and may be received by the query annotator 140 from the search engine 160, for example.

Frequency data is generated from the plurality of sets of structured data tuples (403). The frequency data may comprise the annotation statistics 260 and may be generated by the learning engine 143 using the structured data 155. In some implementations, the frequency data may describe the frequency of some or all possible combinations of attribute values among the structured data tuples from the set of structured data tuples. The frequency data may further include the probability of receiving a query having some or all possible combinations of the attribute values from the set of structured data tuples. The frequency data may be used to determine a probability score for a candidate annotated query based on annotated tokens associated with the annotated query.

A query is received (405). The query may be received by the search engine 160 or the query annotator 140 from a user using the client device 110. The query may have one or more terms.

An annotated query is generated for each set of structured data tuples (407). The annotated queries may be generated by the annotation engine 145 and may be scored as the candidate annotations 245. In some implementations, the annotated query may include a plurality of annotated and free tokens determined by the token engine 241 by parsing the terms of the query using a dictionary or list of attribute values, or words related to the attribute values, from the structured data 155. In addition, the dictionary may also include terms taken from the query data 165. The annotated query generated for each set of tokens may represent the generated annotated query that is the maximal annotated query for that set of tokens.

A probability score is generated for each annotated query (409). The probability score may be generated by the annotation scorer 246 using the annotation statistics.

The generated probability scores are compared to a dynamically generated threshold score (411). The generated probability scores may be compared to the threshold score by the annotation engine 145. The threshold score may be dynamically generated by the annotation engine 145 and may be the probability of the received query appearing in the query data 165. Because the dynamic threshold score represents the probability of the received query appearing in the query data 165, an annotated query with a probability of appearing in a structured data tuple of a table that is below the threshold score is very unlikely and may be discarded. In some implementation, the dynamic threshold may be based on the probability of the terms/tokens comprising the free form query appearing in previously received queries.

Structured data tuples having attribute values that match one or more tokens of a generated annotated query are identified (413). The structured data tuples may be identified by the search engine 160 from the structured data 155. An identifier of a product associated with the identified structured data tuple is presented (415). The identifier may be presented by the search engine 160 to a user at the client device 110. In some implementations, the identifier may be presented in a webpage.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing system 500. In its most basic configuration, computing system 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing system 500 may have additional features/functionality. For example, computing system 500 may include additional storage (removable and/or non-removable) including, but not limited to, magnetic or optical disks or tape. Such additional storage is illustrated in FIG. 5 by removable storage 508 and non-removable storage 510.

Computing system 500 typically includes a variety of computer readable media. Computer readable media can be any available media that can be accessed by device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system 500. Any such computer storage media may be part of computing system 500.

Computing system 500 may contain communications connection(s) 512 that allow the device to communicate with other devices. Computing system 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a query at a computing device through a network, wherein the query comprises one or more terms;
for each of a plurality of sets of structured data tuples, determining a set of tokens for the set of structured data tuples from the terms of the query by the computing device based on attribute values of attributes associated with the structured data tuples in the set of structured data tuples; and
determining one or more annotated queries from each of the sets of tokens by the computing device.

2. The method of claim 1, further comprising:
determining a probability score for each of the determined annotated queries by the computing device;
selecting the annotated query having the highest determined probability score by the computing device; and
identifying, by the computing device, one or more structured data tuples from the plurality of structured data tuples that have attributes with attribute values that match one or more tokens of the selected annotated query.

3. The method of claim 2, wherein the probability score for each of the annotated queries is determined based on predetermined frequencies of the attribute values of the attributes of the structured data tuples in the plurality of sets of data tuples.

4. The method of claim 2, wherein the probability score for each of the annotated queries is determined based on a predetermined likelihood that the annotated query was received.

5. The method of claim 2, wherein selecting the annotated query having the highest determined probability score comprises comparing the highest score to a dynamic threshold, and only selecting the annotated query having the highest score if the highest score is greater than the dynamic threshold.

6. The method of claim 5, wherein the dynamic threshold is determined based on the probability of the received query based on terms of previously received queries.

7. The method of claim 1, wherein the tokens in the set of tokens comprise free tokens and annotated tokens.

8. The method of claim 7, wherein determining one or more annotated queries from each of the sets of tokens by the computing device comprises, for each set of tokens:
determining an annotated query for one or more combinations of tokens from the set of tokens;
determining one or more maximal annotated queries for each of the determined annotated queries; and
selecting the maximal annotated queries for the set of tokens.

9. The method of claim 1, further comprising:
determining a probability score for each of the determined annotated queries;
comparing the determined probability score for each of the determined annotated queries to a dynamic threshold; and
selecting annotated queries having a determined probability score that is greater than the dynamic threshold.

10. A method comprising:
receiving a plurality of sets of structured data tuples at a computing device through a network, wherein each structured data tuple comprises a plurality of attributes and each attribute has an associated value;
generating frequency data from the plurality of sets of structured data tuples by the computing device, the frequency data describing the frequency of one or more combinations of attribute values for the attributes of the structured data tuples in the plurality of sets of structured data tuples;
receiving a query at the computing device through the network, wherein the query comprises one or more terms;
generating one or more annotated queries based on the terms of the query for each of the sets of structured data tuples by the computing device, wherein each annotated query comprises one or more tokens; and
generating a probability score for each of the generated annotated queries based on the generated frequency data by the computing device.

11. The method of claim 10, further comprising comparing the generated probability score for each of the annotated queries with a dynamic threshold, and discarding annotated queries having a generated probability score that is less than the dynamic threshold.

12. The method of claim 10, further comprising:
identifying a structured data tuple having attributes with attribute values that match one or more of the tokens of one or more of the annotated queries;
identifying a product associated with the identified structured data tuple; and
presenting an identifier of the product in response to the received query.

13. The method of claim 10, wherein generating one or more annotated queries based on the terms of the query for each of the sets of structured data tuples comprises, for each set of structured data tuples:
determining a set of tokens for the set of structured data tuples from the terms of the query based on the attribute values of the attributes associated with the structured data tuples in the set of structured data tuples;
generating a plurality of annotated queries using one or more combinations of the tokens in the determined set of tokens; and
selecting one or more maximal annotated queries from the generated plurality of annotated queries.

14. A system comprising:
a learning engine that:
receives a plurality of sets of structured data tuples, wherein each structured data tuple comprises a plurality of attributes and each attribute has an associated value; and
generates frequency data from the plurality of sets of structured data tuples, the frequency data describing the frequency of one or more combinations of attribute values for the attributes of the structured data tuples in the plurality of sets of structured data tuples; and
an annotation engine that:
receives a query comprising one or more terms; and
generates one or more annotated queries based on the terms of the query for each of the sets of structured data tuples wherein each annotated query comprises one or more tokens.

15. The system of claim 14, wherein the annotation engine further generates a probability score for each of the one or more annotated queries based on the generated frequency data.

16. The system of claim 15, wherein the annotation engine selects the annotated query with the highest generated probability score.

17. The system of claim 15, wherein the annotation engine further generates a dynamic threshold for the one or more annotated queries based on a probability of the received query among a plurality of previously received queries.

18. The system of claim 17, wherein the annotation engine further compares the generated probability score for each of the one or more annotated queries with the dynamic threshold, and discards annotated queries having a generated probability score that is less than the dynamic threshold.

19. The system of claim 14, wherein the annotation engine further:
identifies a structured data tuple having attributes with attribute values that match one or more of the tokens of one or more of the annotated queries;
identifies a product associated with the identified structured data tuple; and
presents an identifier of the product in response to the received query.

20. The system of claim 14, wherein generating one or more annotated query based on the terms of the query comprises the annotation engine, for each set of structured data tuples:
determining a set of tokens for the set of structured data tuples from the terms of the query based on the attribute values of the attributes associated with the structured data tuples in the set of structured data tuples;
generating one or more annotated queries using one or more combinations of the tokens in the determined set of tokens; and
selecting one or more maximal annotated queries.
